(19) United States
(12) Patent Application Publication
(10) Pub. No.: US 2016/0140920 A1
(43) Pub. Date: May 19, 2016

(54) LIQUID CRYSTAL DISPLAY DEVICE

(71) Applicant: SAMSUNG DISPLAY CO. LTD., Yongin-City (KR)

(72) Inventors: Joo Suk LEE, Asan-si (KR); Seung Jae KANG, Asan-si (KR); Kyung Sik KIM, Asan-si (KR); Kyo Min KIM, Seoul (KR); Ha Sook KIM, Asan-si (KR); Jang Hyun YEO, Seoul (KR)

(21) Appl. No.: 14/697,181

(22) Filed: Apr. 27, 2015

(30) Foreign Application Priority Data
Nov. 18, 2014 (KR) 10-2014-0161059

(51) Int. Cl. G09G 3/36

(52) U.S. Cl. CPC G09G 3/3614; G09G 2320/0257; G09G 2320/0247; G09G 2320/0209; G09G 2300/0823

(57) ABSTRACT

A liquid crystal display device and a method of driving a liquid crystal display device are provided. The liquid crystal display device includes a display panel, a controller configured to generate and output an inversion switch signal for controlling inversion driving of the display panel by receiving a common voltage fed back from the display panel, and a data driver configured to receive the inversion switch signal and switch an inversion driving scheme. The controller includes a waveform converter for converting the common voltage to a square wave.

### CROSS-REFERENCE TO RELATED APPLICATION

This application claims priority to Korean Patent Application No. 10-2014-0161059 filed on Nov. 18, 2014 in the Korean Intellectual Property Office, and all the benefits accruing therefrom under 35 U.S.C. 119, the contents of which in its entirety are herein incorporated by reference.

### TECHNICAL FIELD

The present inventive concept relates to a liquid crystal display device.

### BACKGROUND

A liquid crystal display device among the display devices has advantages due to a small size, a thin shape, and low power consumption, and is used as a display device of a notebook computer, an office automation device, an audio/video device, and the like. Particularly, an active matrix-type liquid crystal display device, in which a thin film transistor (hereinafter, referred to as a “TFT”) is used as a switching element, is appropriate to display a dynamic image. The liquid crystal display device implements an image by adjusting light transmittance of a liquid crystal cell on a liquid crystal panel according to a grayscale value of a data signal. However, when a direct current voltage having the same polarity is applied to liquid crystal cells arranged on the liquid crystal panel for a long time, a light transmittance property of the liquid crystal cell deteriorates. That is, a polarization and rapid permanent damage of the liquid crystal material is incurred causing an afterimage in an image displayed on the liquid crystal panel.

As a method for preventing the polarization and rapid permanent damage of the liquid crystal material, there is suggested a liquid crystal display device adopting an inversion scheme, which inverts a polarity of data voltage supplied to liquid crystal cells of a display panel with respect to a common voltage Vcom. The inversion scheme includes a frame inversion scheme, a line inversion scheme, a column inversion scheme, and a dot inversion scheme. Among them, the dot inversion scheme, when the pixel's voltage changes its polarity according to the one of neighbor pixels polarity, provides an image with excellent image quality, compared to the frame inversion scheme and the line inversion scheme. In dot inversion scheme, each pixel is displayed in different polarity in each frame and flickering is less noticeable if it is mismatched in the positive and negative frame.

However, when displaying a specific pattern, for example, a check pattern using the dot inversion scheme, a framed inversion effect appears in the liquid crystal display device. Thus, image quality of the liquid crystal display device may deteriorate according to a correlation between a polarity of a data voltage charged in liquid crystal cells and a displayed image pattern. That is, the polarities of the data voltage charged in the liquid crystal cells may not be in a balanced state. That is, any one polarity between a positive polarity and a negative polarity may be dominant. Accordingly, a ripple, in which a reference potential of the liquid crystal cells has a periodic variation, may be generated, and the common voltage Vcom applied to a common electrode may be shifted to the dominant polarity.

FIG. 1 is a diagram illustrating pixel data in which crosstalk is generated in a dot inversion scheme of a liquid crystal display device. FIG. 1 may be a diagram schematically illustrating a smear pattern in which pixel data of a white grayscale and pixel data of a black grayscale are alternated in every two unit pixels (R, G, and B) in the liquid crystal display device driven by a two-dot vertical inversion scheme.

When it is assumed that a black grayscale is implemented by applying a high voltage, one R pixel, two G pixels, and one B pixels are dominant among the pixels in an active state in an N^{th} horizontal line (N line), so that the common voltage may be shifted to the positive polarity due to a ripple. A common voltage Vcom of an N+1^{th} horizontal line N+1 LINE is shifted to a negative polarity contrary to the N^{th} horizontal line N LINE. That is, in the dot inversion scheme, the common voltage may be distorted due to specific image patterns. When the distortion of the common voltage is continuously generated in a subsequent frame, crosstalk may be caused, thereby degrading display quality.

### SUMMARY

The present inventive concept has been made in an effort to provide a liquid crystal display device capable of preventing display quality from deteriorating due to distortion of a common voltage.

The present inventive concept has also been made in an effort to provide a method of driving a liquid crystal display device capable of preventing display quality from deteriorating due to distortion of a common voltage.

Technical problems of the present inventive concept are not limited to the above-mentioned technical problems, and other technical problems, which are not mentioned above, can be clearly understood by those skilled in the art from the following descriptions.

According to an exemplary embodiment of the inventive concept, a liquid crystal display device comprising a display panel, a controller configured to generate and output an inversion switch signal for controlling inversion driving of the display panel by receiving a common voltage fed back from the display panel and a data driver configured to receive the inversion switch signal and switch an inversion driving scheme, wherein the controller includes a waveform converter for converting the common voltage to a square wave.

The waveform converter may include a first comparator including a first non-inverting input terminal, to which the common voltage is applied, and a first inverting input terminal, to which a first reference voltage is applied, and a second comparator including a second non-inverting input terminal, to which a second reference voltage different from the first reference voltage is applied, and a second inverting input terminal to which the common voltage is applied.

The first comparator may compare the common voltage and the first reference voltage, and the second comparator may compare the common voltage and the second reference voltage.

When a level of the common voltage is higher than a level of the first reference voltage, the first comparator outputs a signal having a high level, and when a level of the common voltage is lower than a level of the second reference voltage, the second comparator outputs a signal having a high level.

The signal output from the first comparator may overlap the signal output from the second comparator to form converted data.

The first reference voltage and the second reference voltage may have a same value having different polarities.

The inversion switch signal may change an inversion driving scheme so that a pixel of a positive polarity and a pixel of a negative polarity connected to one pixel row of the display panel are balanced.

The controller may further include a switch signal generator for generating the inversion switch signal according to a duty of the square wave provided by the waveform converter.

The switch signal generator may generate the inversion switch signal according to a duty ratio of the converted data.

The switch signal generator may generate the inversion switch signal according to whether a duty pattern of the converted data corresponds to a predetermined data pattern.

According to an exemplary embodiment of the inventive concept, a method of driving a liquid crystal display device comprising receiving a common voltage fed back from a display panel, converting the common voltage into converted data having a square wave form, generating an inversion switch signal by using the converted data and switching an inversion driving scheme of the display panel by receiving the inversion switch signal.

The converting of the common voltage into the converted data may include comparing the common voltage and a first reference voltage, and comparing the common voltage and a second reference voltage different from the first reference voltage.

When a level of the common voltage is higher than a level of the first reference voltage, a signal having a high level may be output, and when a level of the common voltage is lower than a level of the second reference voltage, a signal having a high level may be output.
wherein the first reference voltage and the second reference voltage may have a same value having different polarities.

The switching of the inversion driving scheme may include switching an inversion driving scheme so that a pixel of a positive polarity and a pixel of a negative polarity connected to one pixel row of the display panel are balanced.

The generating of the inversion switch signal may include detecting a duty of the converted data to generate the inversion switch signal.

The inversion switch signal may be generated according to a duty ratio of the converted data.

The inversion switch signal may be generated according to whether a duty pattern of the converted data corresponds to a predetermined data pattern.

The display panel may be a liquid crystal display panel.

The common voltage may be analog data, and the converted data may be digital data.

The embodiments of the present inventive concept have at least the following effects.

It is possible to minimize deterioration of display quality due to distortion of a common voltage.

The effects according to the embodiments of the present inventive concept are not limited to the contents exemplified above, and more various effects are included in the present specification.

### BRIEF DESCRIPTION OF THE DRAWINGS

The above and other features and advantages of the present inventive concept will become more apparent by describing embodiments in detail thereof with reference to the attached drawings in which:

FIG. 1 is a diagram illustrating pixel data in which crosstalk is generated in a dot inversion scheme of a liquid crystal display device;

FIG. 2 is a block diagram of a liquid crystal display device according to an embodiment of the present inventive concept;

FIG. 3 is a block diagram of a display panel according to the embodiment of the present inventive concept;

FIG. 4 is a block diagram of a controller according to the embodiment of the present inventive concept;

FIG. 5 is a block diagram of an inversion controller;

FIG. 6 is a diagram schematically illustrating a common voltage Vcom in which a ripple is generated;

FIG. 7 is a diagram schematically illustrating conversion of a common voltage into conversion data;

FIG. 8 is a schematic circuit diagram of a waveform converting unit;

FIG. 9 is a diagram schematically illustrating a switch of an inversion scheme; and

FIG. 10 is a flowchart illustrating a method of driving a liquid crystal display device according to another embodiment of the present inventive concept.

### DETAILED DESCRIPTION OF THE EMBODIMENTS

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the inventive concept to those skilled in the art, and the present inventive concept will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present between the element or layer and the another element or layer. In contrast, when an element is referred to as being “directly on”, “directly connected to” or “directly coupled to” another element or layer, there are no intervening elements or layers present between the element or layer and the another element or layer. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, embodiments of the present inventive concept will be described with reference to the accompanying drawings.

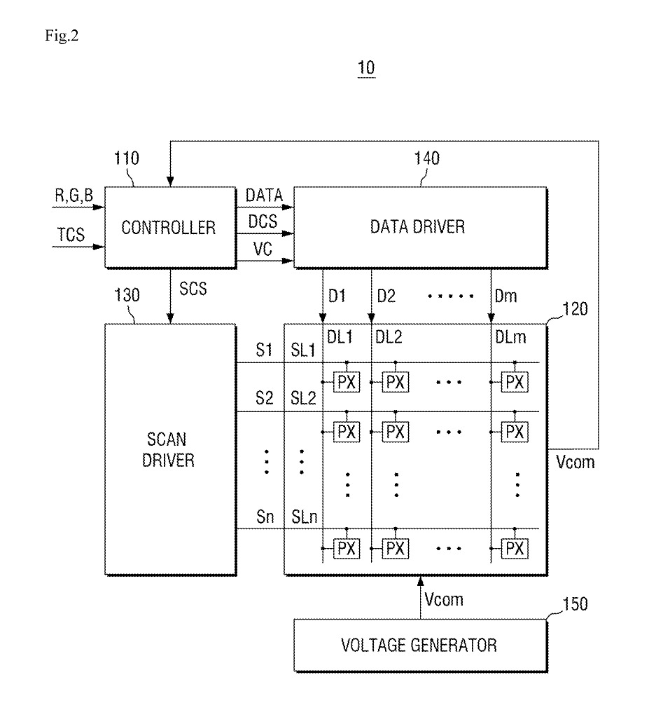

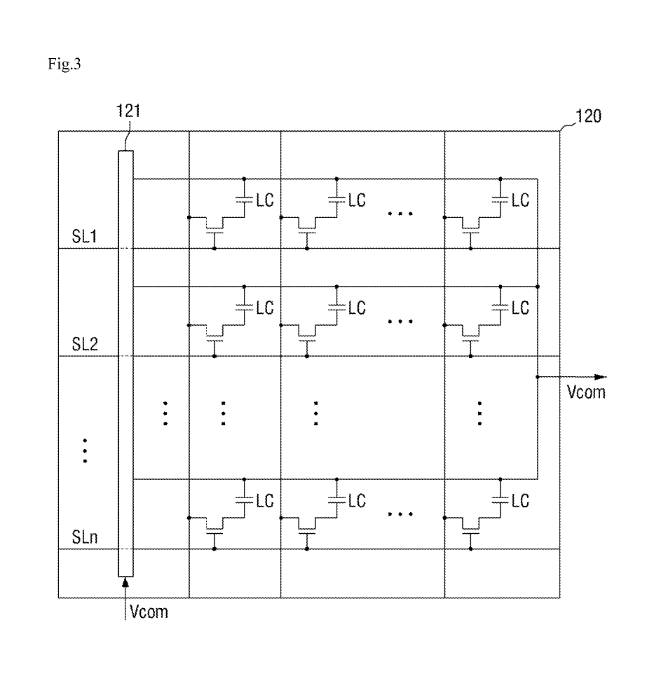

FIG. 2 is a block diagram of a liquid crystal display device according to an embodiment of the present inventive concept, and FIG. 3 is a block diagram of a display panel according to the embodiment of the present inventive concept.

Referring to FIGS. 2 and 3, a liquid crystal display device 10 includes a controller 110, a display panel 120, a scan driver 130, a data driver 140, and a voltage generator 150.

The display panel 120 may be a panel for displaying an image. The display panel 120 may include a first substrate, a second substrate facing the first substrate, and a liquid crystal layer interposed between the first substrate and the second substrate. That is, the display panel 120 may be a liquid crystal panel. Here, the first substrate may be an array substrate on which a plurality of pixels, which is to be described below, and lines connected to the plurality of pixels are formed, and the second substrate may be an encapsulation substrate for covering the first substrate. A common electrode may be formed on a surface of the second substrate facing the first substrate. The common electrode may form a vertical electric field with a pixel electrode formed on a surface of the first substrate, and an arrangement of liquid crystal molecules of the liquid crystal layer may be adjusted according to the electric field generated between the pixel electrode and the common electrode. That is, a common voltage Vcom is applied to the common electrode, and a data voltage, which is to be described below, is applied to the pixel electrode, so that an electric field corresponding to a potential difference between the common voltage and the data voltage may be formed in each pixel. However, the present inventive concept is not limited thereto, and the common electrode may also be formed on the first substrate, and form a horizontal electric field with the pixel electrode of the first substrate to adjust an arrangement of the liquid crystal molecules. Here, light transmittance of the display panel may be controlled according to an arrangement of the liquid crystal molecules which is adjusted according to the electric field.

The display panel 120 may include a plurality of scan lines SL1, SL2, . . . , and SLn, a plurality of data lines DL1, DL2, . . . , and DLm crossing the plurality of scan lines SL1, SL2, . . . , and SLn, a plurality of pixels PXs, each of which is connected to one of the plurality of scan lines SL1, SL2, . . . , and SLn and one of the plurality of data lines DL1, DL2, . . . , and DLm. As described above, the plurality of scan lines SL1, SL2, . . . , and SLn, the plurality of data lines DL1, DL2, . . . , and DLm, and the plurality of pixels PXs may be formed on the first substrate of the display panel 120. The plurality of pixels PXs may be disposed in a matrix shape. The plurality of scan lines SL1, SL2, . . . , and SLn may extend in a row direction, and substantially be parallel to each other. The plurality of scan lines SL1, SL2, . . . , and SLn may include first to n^{th} scan lines SL1, SL2, . . . , and SLn which are sequentially disposed. The plurality of data lines DL1, DL2, . . . , and DLm may cross the plurality of scan lines SL1, SL2, . . . , and SLn. That is, the plurality of data lines DL1, DL2, . . . , and DLm may extend in a second direction d2 that is vertical to a first direction dl, and substantially be parallel to each other.

Each of the pixels PXs may be connected to one of the plurality of scan lines SL1, SL2, . . . , and SLn and one of the plurality of data lines DL1, DL2, . . . , and DLm. The plurality of pixels PXs may receive data voltages applied to the connected data lines DL1, DL2, . . . , and DLm in response to scan signals S1, S2, . . . , and Sn provided from the connected scan lines SL1, SL2, . . . , and SLn, respectively. That is, each pixel PX may include a transistor which is turned on by the scan signal to transmit the data voltage to the pixel electrode.

The controller 110 may receive image signals R, G, and B, and a control signal TCS of the image signals R, G, and B from the outside. Here, the control signal TCS may be a vertical synchronization signal Vsync, a horizontal synchronization signal Hsync, a main clock signal MCLK, a data enable signal DE, and the like. The controller 110 may process the signals to be appropriate to an operation condition of the display panel 120, and then generate image data DATA, a data control signal DCS, and a scan control signal SCS. The data control signal DCS may include a horizontal synchronization start signal STH for instructing an input start of the image data DATA, a load signal TP for instructing an application of the data voltage to the data lines DL1, DL2, . . . , and DLm, and the like. Further, the scan control signal SCS may include a scan initiation signal STV for instructing an output start of the scan signals S1, S2, . . . , and Sn, and a gate clock signal CPV for controlling an output time of a scan on pulse, and the like.

The scan driver 130 may receive the scan control signal SCS from the controller 110. The scan driver 130 may output the plurality of scan signals S1, S2, . . . , and Sn corresponding to the received scan control signal SCS, and provide the plurality of output scan signals S1, S2, . . . , and Sn to the display panel 110.

The data driver 140 may include a shift register, a latch, a digital analog converter (DAC), and the like. The data driver 140 may receive the data control signal DCS, the image data DATA and an inversion switch signal VC from the controller 110. The data driver 140 may select a reference voltage in accordance with the data control signal DCS, and convert the input image data DATA having a digital waveform into a plurality of data voltages in response to the selected reference voltage. The data driver 140 may output the plurality of generated data voltages to the display panel 110.

The voltage generator 150 may supply operation power of the display device 10, and provide the common voltage Vcom to the display panel 120. Further, the voltage generator 150 may also provide a reference voltage (not illustrated) to the aforementioned data driver 140.

Here, the display panel 120 may include a common wire 121. The common wire 121 may be a wire for supplying the common voltage Vcom provided from the voltage generator 150 to the common electrode of the display panel 120.

As illustrated in FIG. 3, the common wire 121 may extend along one side of the display panel 120 in a predetermined direction. Here, the common wire 121 may be formed on the aforementioned first substrate or second substrate, and may be insulated from the plurality of scan lines SL1, SL2, . . . , and SLn. The common electrode may be integrally formed on the first substrate or the second substrate, and the common voltage Vcom may be provided through the common wire 121. The common voltage Vcom may generate an electric field with a data voltage provided through the transistor of each pixel in a liquid crystal layer LC. The common voltage Vcom may provide a reference potential to the liquid crystal layer LC. Here, the display panel 120 may be operated in a dot inversion scheme. The common voltage Vcom may be distorted due to specific image patterns. That is, a ripple that the reference potential of the liquid crystal display has a periodic variation, may be generated.

The liquid crystal display device 10 according to the embodiment of the present inventive concept may detect the ripple in the common voltage Vcom in real time. That is, the common voltage Vcom may be fed back to the controller 100. Here, the common voltage Vcom of a predetermined horizontal line may be fed back to the controller 110. That is, the controller may measure the current common voltage Vcom in response to the scan signals S1, S2, . . . , and Sn for sequentially activating the scan lines SL1, SL2, . . . , and SLn, respectively. FIG. 3 schematically illustrates a feedback process of the common voltage Vcom, and a circuit structure of the display panel 120, a position of a node to which the common voltage Vcom is fed back, and the like are not limited to FIG. 3.

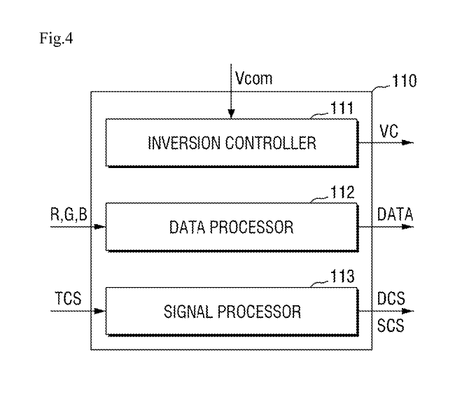

Hereinafter, an operation and a configuration of the present inventive concept, which prevents display quality from deteriorating by using the fed back common voltage Vcom, will be described in more detail with reference to FIGS. 4 to 9.

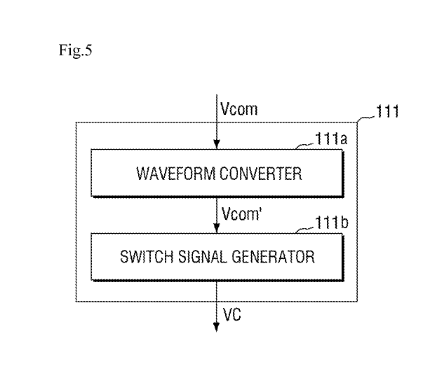

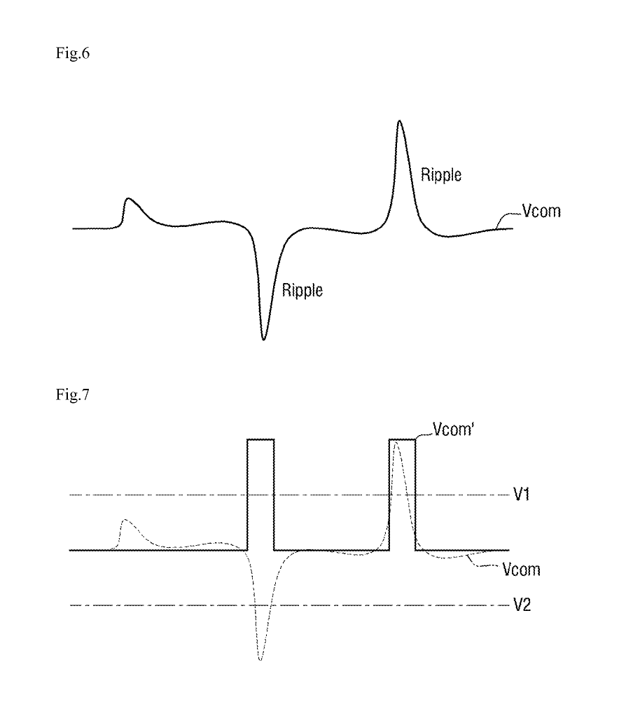

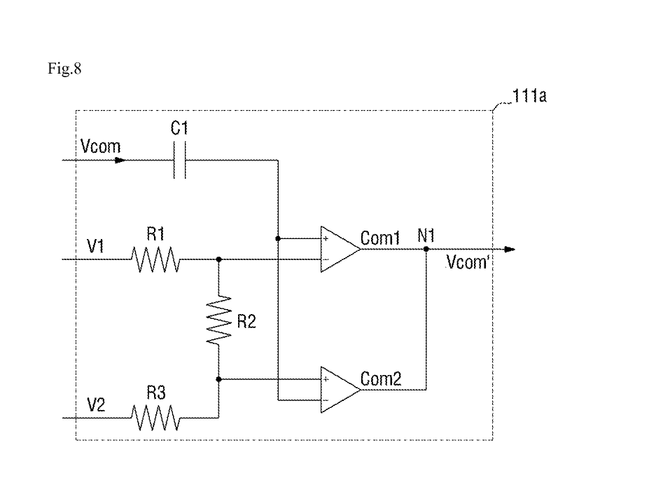

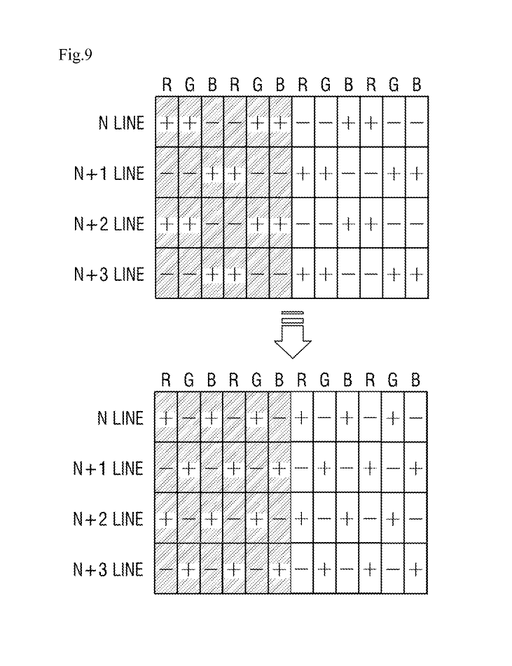

FIG. 4 is a block diagram of the controller according to the embodiment of the present inventive concept, FIG. 5 is a block diagram of an inversion controller, FIG. 6 is a diagram schematically illustrating a common voltage Vcom in which a ripple is generated, FIG. 7 is a diagram schematically illustrating conversion of a common voltage into conversion data, FIG. 8 is a schematic circuit diagram of a waveform converting unit, and FIG. 9 is a diagram schematically illustrating a switch of an inversion scheme.

Referring to FIGS. 4 to 9, the controller 110 includes an inversion controller 111, a data processor 112, and a signal processor 113. Here, the data processor 112 and the signal processor 113 may generate the aforementioned image data DATA and various control signals, and provide the generated image data DATA and various control signals to other constituent elements of the display device 10.

The inversion controller 111 may receive the fed back common voltage Vcom of the display panel 120. The inversion controller 111 may detect the common voltage Vcom of the display panel 120 in real time, and determine whether the common voltage Vcom has a problem. Here, whether or not the common voltage Vcom is detected and a detection frequency may be changed by a setting of a user and the like.

The inversion controller 111 may determine whether a ripple is generated in the common voltage Vcom, and change the dot inversion scheme when the generated ripple is equal to or higher than a predetermined reference value. That is, when the inversion controller 111 recognizes that the ripple of the common voltage Vcom according to the current inversion scheme is equal to or higher than a predetermined reference value, the inversion controller 111 may output an inversion switch signal VC for changing the inversion scheme to the data driver 140. The data driver 140 may receive the inversion switch signal VC and switch the driving scheme to dot inversion scheme.

More particularly, the inversion controller 111 may include a waveform converter 111a and a switch signal generator 111b. The waveform converter 111a may convert a waveform of the fed back common voltage Vcom to a square wave. The common voltage Vcom provided from the display panel 120 to the waveform converter 111a may be analog data that represent changing values as continuously variable. The waveform converter 111a may convert the fed back common voltage Vcom having an analog signal to a square wave. The square wave output by the waveform converter 111a may be digital data having a low level and a high level. That is, the waveform converter 111a may convert the fed back common voltage Vcom, which is analog data, into converted data Vcom′, which is digital data. Here, when the common voltage Vcom is higher than a predetermined reference voltage V1 or V2, the waveform converter 111a may output the common voltage Vcom at a high level. As illustrated in FIG. 7, the ripple of the fed back common voltage Vcom may have a higher level than a predetermined reference voltage V1 or V2. The ripple having a higher level than a predetermined reference voltage V1 or a lower level than a predetermined reference voltage V2 may be output at a high level in the converted data as illustrated in FIG. 7.

The waveform converter 111a may include a first comparator Com1 and a second comparator Com2. Further, the waveform converter 111a may further include resistors R1, R2, and R3 for forming a potential different and a capacitor C1 maintaining the input common voltage Vcom. Each of the first comparator Com1 and the second comparator Com2 may include a first non-inverting input terminal (+) and a first inverting input terminal (−). The fed back common voltage Vcom fed back from the display panel 120 may be applied to the first non-inverting input terminal (+) of the first comparator Com1, and a first reference voltage V1 may be applied to the first inverting input terminal (−) of the first comparator Com1. When a level of the applied common voltage Vcom is higher than that of the first reference voltage V1, the first comparator Com1 may output a high level signal, and when the level of the applied common voltage Vcom is lower than that of the first reference voltage V1, the first comparator Com1 may output a low level signal. A second reference voltage V2 that is different from the first reference voltage V1 may be applied to the second non-inverting input terminal (+) of the second comparator Com2. The first reference voltage V1 may be a voltage having a predetermined level set for determining whether or not the ripple has a higher level than a predetermined reference voltage V1. Here, the second reference voltage V2 may be a voltage having the same level as that of the first reference voltage V1, but may have a different polarity from that of the first reference voltage V1. Here, the first reference voltage V1 may have a positive polarity, and the second reference voltage V2 may have a negative polarity. The fed back common voltage Vcom fed back from the display panel 120 may be applied to the second inverting input terminal (−) of the second comparator Com2. When a level of the fed back common voltage Vcom is lower than that of the second reference voltage V2, the second comparator Com2 may output a high level signal, and when the level of the common voltage Vcom is higher than that of the second reference voltage V2, the second comparator Com2 may output a low level signal. That is, the first comparator Com1 may detect the ripple of the positive polarity of the fed back common voltage Vcom, and the second comparator Com2 may detect the ripple of the negative polarity of the fed back common voltage Vcom. The signals output from the first comparator Com1 and the second comparator Com2 may overlap each other, and the converted data Vcom′ having a square wave form having a predetermined duty may be generated. The waveform converter 111a may receive the fed back common voltage Vcom, and generate the converted data Vcom′ having a square wave form in which a ripple component of the fed back common voltage Vcom having a higher level than a predetermined positive reference voltage V1 and a lower level than a predetermined negative reference voltage V2 is set to a high level. The waveform converter 111a may provide the converted data Vcom′ to the switch signal generator 111b.

The switch signal generator 111b may generate an inversion switch signal VC according to the converted data Vcom. The inversion switch signal VC may be a signal for controlling inversion driving of the display panel 120. That is, the inversion driving scheme of the display panel 120 may be changed by the inversion switch signal VC. More particularly, the switch signal generator 111b may generate an inversion switch signal VC according to a waveform of the converted data Vcom. The converted data Vcom′ may have the square wave form, and the switch signal generator 111b may recognize the duty of the converted data Vcom′ and generate the inversion switch signal VC. That is, the switch signal generator 111b may determine whether to switch driving scheme based on a ratio of the high level in the converted data Vcom′. As described above, in the dot inversion scheme, a ripple of the common voltage is generated due to the specific image patterns, so that the ripple may be generated in an opposite polarity in successive pixel rows. The ripple may be detected sequentially in the converted data Vcom′. Accordingly, the switch signal generator 111b may determine whether to switch the inversion scheme according to a duty pattern of the converted data Vcom′. That is, the switch signal generator 111b may switch the inversion scheme when the duty pattern of the converted data Vcom′ corresponds to a predetermined pattern. However, the present inventive concept is not limited thereto, and in several embodiments, the switch signal generator 111b may switch the inversion scheme when a duty ratio of the converted data Vcom′ is equal to or higher than a predetermined duty ratio. That is, the switch signal generator 111b may switch the inversion scheme according to the duty ratio of the converted data Vcom′.

That is, the switch signal generator 111b may easily determine whether to switch the inversion scheme by detecting a duty of the converted data Vcom′ that is digital data. When it is determined that it is necessary to switch the inversion scheme, the switch signal generator 111b may generate the inversion switch signal VC and output the generated inversion switch signal VC to the data driver 140. The dot inversion scheme may be changed as illustrated in FIG. 9 by the inversion switch signal VC. That is, the dot inversion scheme may be changed from two-dot inversion to one-dot inversion. Each pixel line does not bias to a specific polarity in the one dot inversion scheme, so that a voltage ripple may be prevented in the common electrode by changing the inversion scheme to the one dot inversion scheme. The change of the inversion scheme is not limited to FIG. 9, and the inversion scheme may be changed to another inversion scheme in which a positive polarity pixel and a negative polarity pixel in each horizontal pixel line are balanced.

The liquid crystal display device according to the embodiment of the present inventive concept may change the inversion scheme by converting the common voltage formed on the display panel into a square wave form and easily determining whether the ripple having the higher level than a predetermined reference voltage V1 or V2 is generated in the common voltage according to a duty of the converted square wave. Accordingly, it is possible to prevent display quality from deteriorating.

Hereinafter, a method of driving a liquid crystal display device according to another embodiment of the present inventive concept will be described.

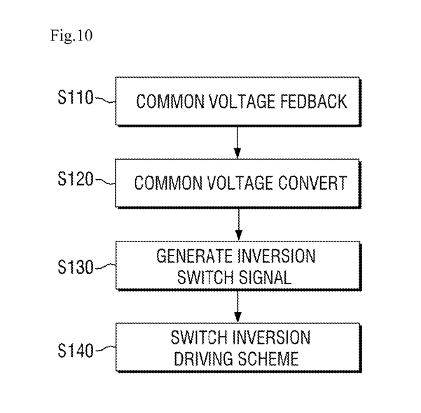

FIG. 10 is a flowchart illustrating a method of driving a liquid crystal display device according to another embodiment of the present inventive concept.

Referring to FIG. 10, a method of driving a liquid crystal display device according to another embodiment of the present inventive concept includes receiving a fed back common voltage from a display panel (S110), converting the analog common voltage into converted data that is a square wave (S120), generating an inversion switch signal by using the converted data (S130), and switching an inversion driving scheme (S140).

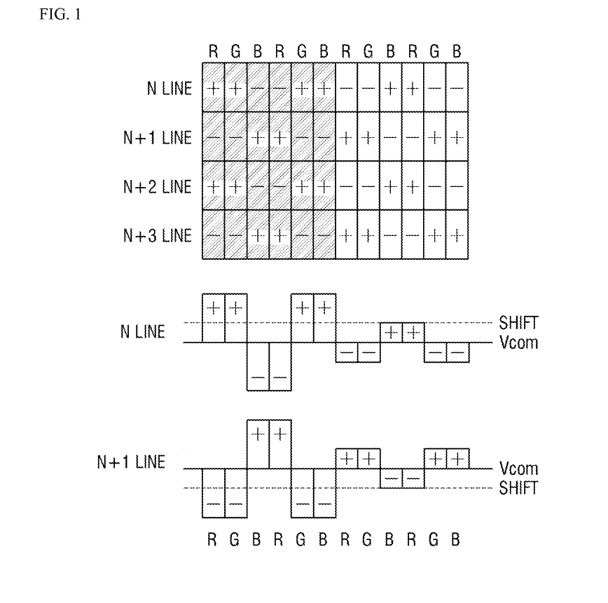

The liquid crystal display device of the present embodiment may be the liquid crystal display device according to the embodiment of FIGS. 1 to 9. That is, the liquid crystal display device of the present embodiment may be the liquid crystal display device driven in the two dot inversion scheme. Descriptions of the other configurations of the liquid crystal display device of the present embodiment overlap the aforementioned contents, and thus are omitted.

First, a fed back common voltage from the display panel is received (S110).

A common voltage Vcom formed in the display panel 120 may be fed back and input to an inversion controller 111 of the controller 110. The inversion controller 111 may detects the fed back common voltage Vcom of the display panel 120 in real time. Whether or not the fed back common voltage Vcom is detected and a detection frequency may be changed by a setting of a user and the like. More particularly, the inversion controller 111 may include a waveform converter 111a and a switch signal generator 111b, and the fed back common voltage Vcom may fed back to the waveform converter 111a.

Subsequently, the common voltage is converted into digital signal (S120).

The waveform converter 111a may convert the common voltage Vcom to a square wave. The square wave output from the waveform converter 111a may be digital data including a low level and a high level. That is, the waveform converter 111a may convert the fed back common voltage Vcom, which is analog data to converted data Vcom′, which is digital data. Here, when the fed back common voltage Vcom is higher than a predetermined reference voltage V1 or V2, the waveform converter 111a output the converted data Vcom′ having a high level. The ripple of the fed back common voltage Vcom may have a higher level than a normal potential. More particularly, the converting of the fed back common voltage into the converted data Vcom′ may include comparing a positive ripple of the fed back common voltage Vcom with a first reference voltage V1, and comparing a negative ripple of the fed back common voltage Vcom with a second reference voltage V2. The first reference voltage V1 may be a voltage having a predetermined level for determining the ripple. Here, the second reference voltage V2 may be a voltage having the same level as that of the first reference voltage V1, but may have a different polarity from that of the first reference voltage V1. That is, the first reference voltage V1 may have a positive polarity, and the second reference voltage V2 may have a negative polarity. Here, the waveform converter 111a may include a first comparator Com1 and a second comparator Com2.

When the fed back common voltage Vcom is higher than the first reference voltage V1, the first comparator Com1 may output a signal having a high level, and when the fed back common voltage Vcom is lower than the first reference voltage V1, the first comparator Com1 may output a signal having a low level. When the fed back common voltage Vcom is higher than the second reference voltage V2, the second comparator Com2 may output a signal having a low level, and when the level of the common voltage Vcom is lower than the second reference voltage V2, the second comparator Com2 may output a signal having a high level. That is, the first comparator Com1 may detect the ripple of the positive polarity of the fed back common voltage Vcom having a higher level than a predetermined reference voltage V1, and the second comparator Com2 may detect the ripple of the negative polarity of the fed back common voltage Vcom having a lower level than a predetermined reference voltage V2. The signals output from the first comparator Com1 and the second comparator Com2 may overlap each other, and the converted data Vcom′ having a square wave form having a predetermined duty may be generated. The generated converted data Vcom′ may be provided to the switch signal generator 111b.

Next, an inversion switch signal is generated (S130).

An inversion switch signal VC may be generated by using the converted data Vcom′. Particularly, the inversion switch signal VC may be generated according to a duty of the converted data Vcom′. The inversion switch signal VC may be a signal for controlling inversion driving of the display panel 120. That is, the inversion driving scheme of the display panel 120 may be changed by the inversion switch signal VC. The switch signal generator 111b may generate the inversion switch signal VC according to a waveform of the converted data Vcom′. The converted data Vcom′ may have the square wave form, and the switch signal generator 111b may recognize the duty of the converted data Vcom′ and generate the inversion switch signal VC. The switch signal generator 111b may determine whether to switch the inversion scheme according to a duty pattern of the converted data Vcom′. That is, the switch signal generator 111b may switch the inversion scheme when the duty pattern of the converted data Vcom′ corresponds to a predetermined pattern. However, the present inventive concept is not limited thereto, and in several embodiments, the switch signal generator 111b may switch the inversion scheme when a duty ratio of the converted data Vcom′ is equal to or higher than a predetermined duty ratio. That is, the switch signal generator 111b may switch the inversion scheme according to the duty ratio of the converted data Vcom′. That is, the switch signal generator 111b may easily determine whether to switch the inversion scheme by detecting a duty of the converted data Vcom′ that is digital data. When it is determined that it is necessary to switch the inversion scheme, the switch signal generator 111b may generate the inversion switch signal VC. The generated inversion switch signal VC may be output to the data driver 140.

Subsequently, the inversion driving scheme is switched (S140).

The inversion driving scheme may be switched by the inversion switch signal VC. The inversion driving scheme may be switched so that a pixel of a positive polarity and a pixel of a negative polarity connected to one pixel row of the display panel 120 are balanced. For example, the inversion driving scheme may be changed from two-dot inversion to one-dot inversion, but the present inventive concept is not limited thereto.

The method of driving the liquid crystal display device according to the present embodiment may change the inversion scheme by converting the fed back common voltage formed on the display panel into a square wave form and easily determining whether the ripple having a higher level than a predetermined positive reference voltage or a lower level than a predetermined negative reference voltage is generated in the common voltage according to a duty of the converted square wave. Accordingly, it is possible to prevent display quality from deteriorating.

The foregoing is illustrative of the present inventive concept and is not to be construed as limiting the scope of the inventive concept. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A liquid crystal display device, comprising:
a display panel;
a controller configured to generate and output an inversion switch signal for controlling inversion driving of the display panel by receiving a common voltage fed back from the display panel; and
a data driver configured to receive the inversion switch signal and switch an inversion driving scheme,
wherein the controller includes a waveform converter for converting the common voltage to a square wave.

2. The liquid crystal display device of claim 1, wherein the waveform converter includes a first comparator including a first non-inverting input terminal, to which the common voltage is applied, and a first inverting input terminal, to which a first reference voltage is applied, and a second comparator including a second non-inverting input terminal, to which a second reference voltage different from the first reference voltage is applied, and a second inverting input terminal to which the common voltage is applied.

3. The liquid crystal display device of claim 2, wherein the first comparator compares the common voltage and the first reference voltage, and the second comparator compares the common voltage and the second reference voltage.

4. The liquid crystal display device of claim 3, wherein when a level of the common voltage is higher than a level of the first reference voltage, the first comparator outputs a signal having a high level, and when a level of the common voltage is lower than a level of the second reference voltage, the second comparator outputs a signal having a high level.

5. The liquid crystal display device of claim 4, wherein the signal output from the first comparator overlaps the signal output from the second comparator to form converted data.

6. The liquid crystal display device of claim 2, wherein the first reference voltage and the second reference voltage have a same value having different polarities.

7. The liquid crystal display device of claim 1, wherein the inversion switch signal changes an inversion driving scheme so that a pixel of a positive polarity and a pixel of a negative polarity connected to one pixel row of the display panel are balanced.

8. The liquid crystal display device of claim 1, wherein the controller further includes a switch signal generator for generating the inversion switch signal according to a duty of the square wave provided by the waveform converter.

9. The liquid crystal display device of claim 8, wherein the switch signal generator generates the inversion switch signal according to a duty ratio of the converted data.

10. The liquid crystal display device of claim 8, wherein the switch signal generator generates the inversion switch signal according to whether a duty pattern of the converted data corresponds to a predetermined data pattern.

11. A method of driving a liquid crystal display device, comprising:
receiving a common voltage fed back from a display panel;
converting the common voltage into converted data having a square wave form;
generating an inversion switch signal by using the converted data; and
switching an inversion driving scheme of the display panel by receiving the inversion switch signal.

12. The method of claim 11, wherein the converting of the common voltage into the converted data includes comparing the common voltage and a first reference voltage, and comparing the common voltage and a second reference voltage different from the first reference voltage.

13. The method of claim 12, wherein when a level of the common voltage is higher than a level of the first reference voltage, a signal having a high level is output, and when a level of the common voltage is lower than a level of the second reference voltage, a signal having a high level is output.

14. The method of claim 12, wherein the first reference voltage and the second reference voltage have a same value having different polarities.

15. The method of claim 11, wherein the switching of the inversion driving scheme includes switching an inversion driving scheme so that a pixel of a positive polarity and a pixel of a negative polarity connected to one pixel row of the display panel are balanced.

16. The method of claim 11, wherein the generating of the inversion switch signal includes detecting a duty of the converted data to generate the inversion switch signal.

17. The method of claim 16, wherein the inversion switch signal is generated according to a duty ratio of the converted data.

18. The method of claim 16, wherein the inversion switch signal is generated according to whether a duty pattern of the converted data corresponds to a predetermined data pattern.

19. The method of claim 11, wherein the display panel is a liquid crystal display panel.

20. The method of claim 11, wherein the common voltage is analog data, and the converted data is digital data.
